(19) United States
(12) Patent Application Publication
(10) Pub. No.: US 2025/0372111 A1
(43) Pub. Date: Dec. 4, 2025

(54) POWER-BASED NOISE REDUCTION DURING A VOICE CALL

(71) Applicant: QUALCOMM Incorporated, San Diego, CA (US)

(72) Inventors: Anuj DESHMUKH, NAGPUR (IN); Asif Imroz MOHAMMED, Hyderabad (IN)

(21) Appl. No.: 18/680,342

(22) Filed: May 31, 2024

(51) Int. Cl. G10L 21/0208; G10L 25/30; H04M 3/00

(52) U.S. Cl. CPC G10L 21/0208; G10L 25/30; H04M 3/002; G10L 2021/02082

(57) ABSTRACT

A device includes a memory configured to buffer an audio input from an audio source. The audio input corresponds to a voice call. The device also includes an audio processor. The audio processor is configured to select, based on a power indicator, a noise reducer mode from multiple noise reducer modes. The audio processor is also configured to generate, based on the selected noise reducer mode, an audio output based on the audio input. The audio processor is further configured to output the audio output.

### I. FIELD

The present disclosure is generally related to performing audio processing based on a detected power level during a voice call.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture user speech from one or more microphones and encode the user speech for transmission to a remote device during a voice call, such as a voice call over a long-term evolution (LTE) network or new radio (NR) network. In some cases, power consumption associated with the voice call can be reduced by having components associated with the voice call, such as a modem and a processor that encodes the user's speech for transmission, enter a low-power state during periods of the voice call where uplink and downlink communications are not scheduled to occur.

Audio enhancements can improve audio quality by reducing noise. For example, echo cancellation and noise suppression performed on an audio signal can improve the audio quality of the audio signal. However, conventional advanced echo cancellation and noise suppression techniques can be power intensive (e.g., consume a relatively large amount of battery power). As a result, the use of conventional advanced echo cancellation and noise suppression techniques can result in higher power consumption during a voice call, which can increase the discharge rate of a battery of a mobile communication device, decrease the usage time of the mobile communication device before having to recharge the battery, and negatively impact a user experience.

### III. SUMMARY

According to an aspect of the present disclosure, a device includes a memory configured to buffer an audio input from an audio source. The audio input corresponds to a voice call. The device also includes an audio processor. The audio processor is configured to select, based on a power indicator, a noise reducer mode from multiple noise reducer modes. The audio processor is also configured to generate, based on the selected noise reducer mode, an audio output based on the audio input. The audio processor is further configured to output the audio output.

According to another aspect of the present disclosure, a method of audio processing by an audio processor is disclosed. The method includes selecting, based on a power indicator, a noise reducer mode from multiple noise reducer modes. The method also includes generating, based on the selected noise reducer mode, an audio output based on an audio input that corresponds to a voice call. The method further includes outputting the audio output.

According to another aspect of the present disclosure, a non-transitory computer-readable medium stores instructions that, when executed by one or more processors, cause the one or more processors to select, based on a power indicator, a noise reducer mode from multiple noise reducer modes. The instructions, when executed by the one or more processors, further cause the one or more processors to generate, based on the selected noise reducer mode, an audio output based on an audio input that corresponds to a voice call. The instructions, when executed by the one or more processors, also cause the one or more processors to output the audio output.

According to another embodiment of the present disclosure, an apparatus includes means for selecting, based on a power indicator, a noise reducer mode from multiple noise reducer modes. The apparatus also includes means for generating, based on the selected noise reducer mode, an audio output based on an audio input that corresponds to a voice call. The apparatus further includes means for outputting the audio output.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an illustrative aspect of a system operable to perform power-based noise reduction during a voice call, in accordance with some examples of the present disclosure.

FIG. 2 is a block diagram of an example of particular aspects of the system of FIG. 1, in accordance with some examples of the present disclosure.

FIG. 3 is a block diagram of particular aspects of the system of FIG. 2, in accordance with some examples of the present disclosure.

FIG. 4 is a block diagram of an example of particular aspects of the system of FIG. 1, in accordance with some examples of the present disclosure.

FIG. 5 is a block diagram of particular aspects of the system of FIG. 4, in accordance with some examples of the present disclosure.

FIG. 6 is a timing diagram of an illustrative aspect of a system operable to perform power-based noise reduction during a voice call, in accordance with some examples of the present disclosure.

FIG. 7 is a diagram of an illustrative aspect of an integrated circuit operable to perform power-based noise reduction during a voice call, in accordance with some examples of the present disclosure.

FIG. 8 is a diagram of an illustrative aspect of a system that includes a mobile device operable to perform power-based noise reduction during a voice call, in accordance with some examples of the present disclosure.

FIG. 9 is a diagram of an illustrative aspect of a system that includes a headset operable to perform power-based noise reduction during a voice call, in accordance with some examples of the present disclosure.

FIG. 10 is a diagram of an illustrative aspect of a system that includes a wearable electronic device operable to perform power-based noise reduction during a voice call, in accordance with some examples of the present disclosure.

FIG. 11 is a diagram of an illustrative aspect of a system that includes a voice-controlled speaker system operable to perform power-based noise reduction during a voice call, in accordance with some examples of the present disclosure.

FIG. 12 is a diagram of an illustrative aspect of a system that includes a vehicle operable to perform power-based noise reduction during a voice call, in accordance with some examples of the present disclosure.

FIG. 13 is a flowchart of an example of a method of power-based noise reduction during a voice call, in accordance with some examples of the present disclosure.

FIG. 14 is a block diagram of a particular illustrative example of a device that is operable to perform power-based noise reduction during a voice call, in accordance with some examples of the present disclosure.

### V. DETAILED DESCRIPTION

Audio enhancements can improve audio quality by suppressing noise and cancelling echo. However, a problem with such audio processing includes power consumption and battery drain during a voice call. To illustrate, audio enhancements can result in higher power consumption during a voice call, which can increase the discharge rate of a battery of a mobile communication device, decrease the usage time of the mobile communication device before having to recharge the battery, and negatively impact a user experience.

Aspects described herein provide solutions to these, and other, problems by using power-based noise reduction in a transmit path, a receive path, or both, during a voice call. For example, according to a particular aspect, a noise reducer mode from multiple noise reducer modes is selected based on a power indicator associated with a device. The power indicator may indicate a power level of a battery of the device or a charging status of the battery. The multiple modes may be associated with a mode or a configuration of a noise reducer of an audio processor configured to process an audio input associated with a voice call. In some example, the multiple modes include a first mode having a first power consumption rate by the noise reducer, and a second mode having a second power consumption rate by the noise reducer that is less than the first power consumption rate. In some implementations, at least one mode of the multiple modes is associated with the noise reducer being deactivated or bypassed.

The audio processor may configure the noise reducer based on the selected mode. In some implementations, the noise reducer can be configured to perform high performance noise reduction, such as a neural network noise reduction engine (e.g., a neural network (FNN) engine), when the power level of a battery is greater than a first threshold, when a battery is in a charging state, or a combination thereof. Alternatively, the noise reducer can be configured to perform noise reduction (other than the high performance noise reduction) when the power level is less than or equal to the first threshold. In some embodiments, the noise reducer is configured to perform echo cancellation noise suppression (ECNS) operation or a single microphone echo cancellation noise suppression (SMECNS) operation when the power level is lower than or equal to the first threshold. Alternatively, the noise reducer can be configured to be deactivated or bypassed when the power level of the battery is less than or equal to a second threshold that is lower than the first threshold.

The audio processor may process the audio input using the configured noise reducer to generate an audio output. The audio output can be output by the audio processor to enable a modem to initiate transmission based on the audio output, or to enable a speaker to generate a playback based on the audio output.

In accordance with some aspects, a mode for the noise reducer can be selected based on the power indicator. Accordingly, as a power level of the battery decreases over time, the mode of the noise reducer can be switched such that the noise reducer is configured to operate and consume power at a lower power consumption rate. Additionally, or alternatively, as the power level of the battery continues to decrease, the mode of the noise reducer can be selected to deactivate the noise reducer. Accordingly, the noise reducer can be selectively configured to reduce power consumption during a voice call, which can decrease the discharge rate of a battery of a mobile communication device, increase the usage time of the mobile communication device before having to recharge the battery, and improve a user experience.

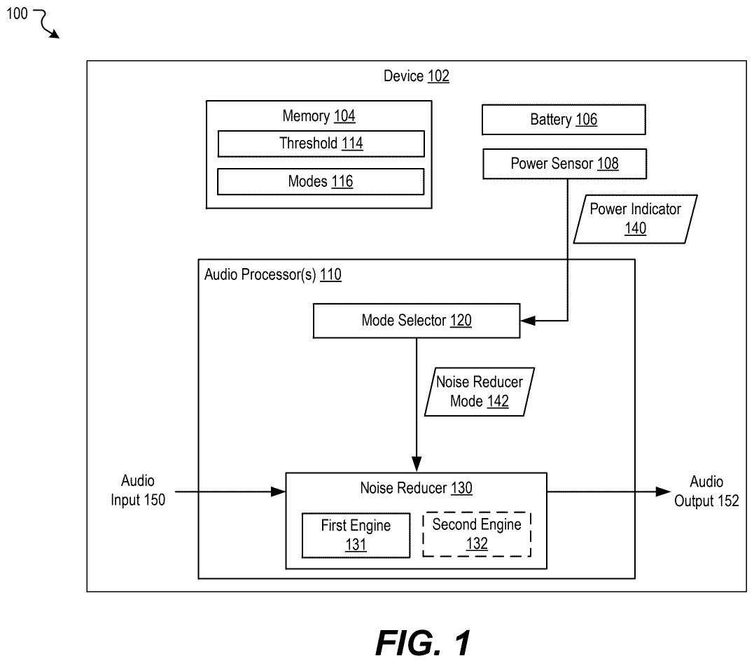

Particular aspects of the present disclosure are described below with reference to the drawings. In the description, common features are designated by common reference numbers. As used herein, various terminology is used for the purpose of describing particular embodiments only and is not intended to be limiting of embodiments. For example, the singular forms “a,” “an,” and “the” are intended to include the plural forms as well, unless the context clearly indicates otherwise. Further, some features described herein are singular in some embodiments and plural in other embodiments. To illustrate, FIG. 1 depicts a device 102 including one or more audio processors (“audio processor(s)” 110 of FIG. 1), which indicates that in some embodiments the device 102 includes a single audio processor 110 and in other embodiments the device 102 includes multiple audio processors 110. For ease of reference herein, such features are generally introduced as “one or more” features and are subsequently referred to in the singular or optional plural (as indicated by “(s)” in the name of the feature) unless aspects related to multiple of the features are being described.

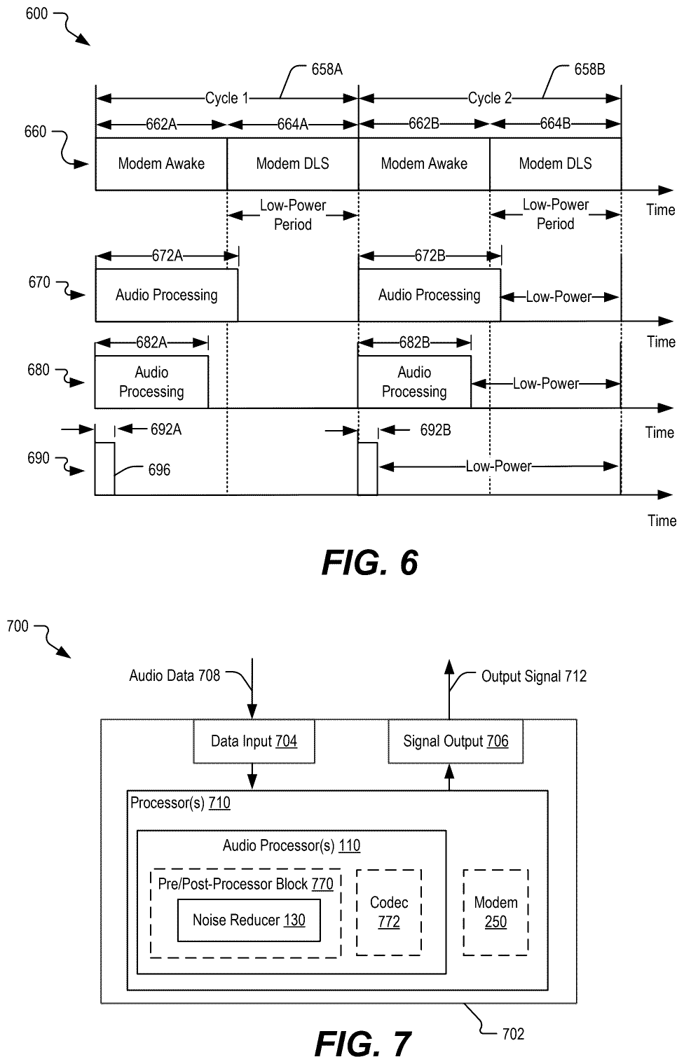

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 6, multiple time periods in which a modem is in an active state are illustrated and associated with reference numbers 662A and 662B. When referring to a particular one of these time periods, such as a time period 662A, the distinguishing letter “A” is used. However, when referring to any arbitrary one of these time periods or to these time periods as a group, the reference number 662 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. Likewise, the term “aspects” does not require that all aspects of the disclosure include the discussed feature, advantage or mode of operation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some embodiments, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

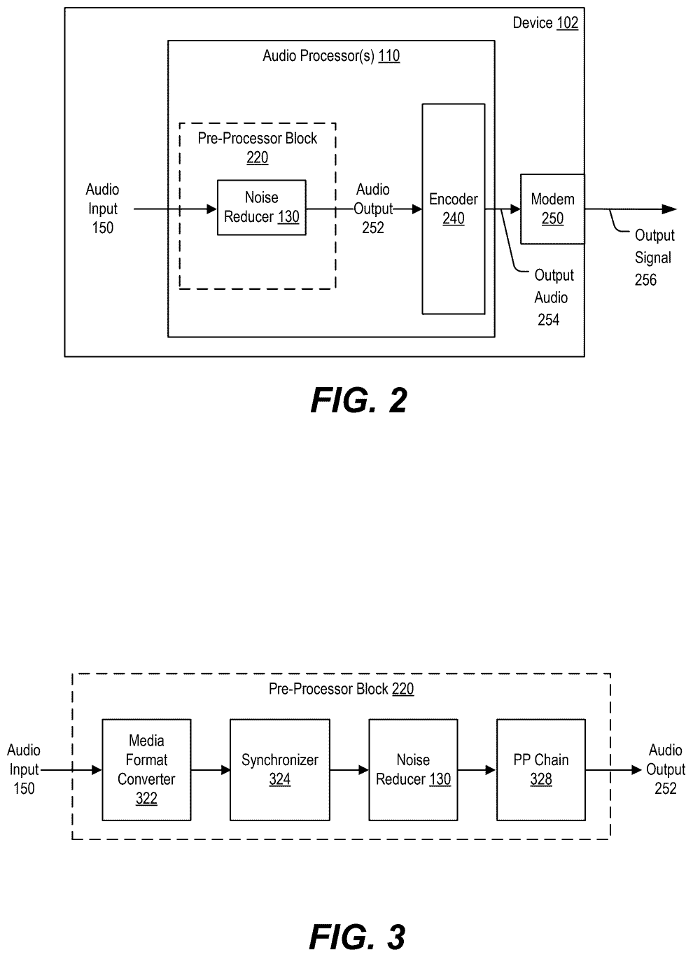

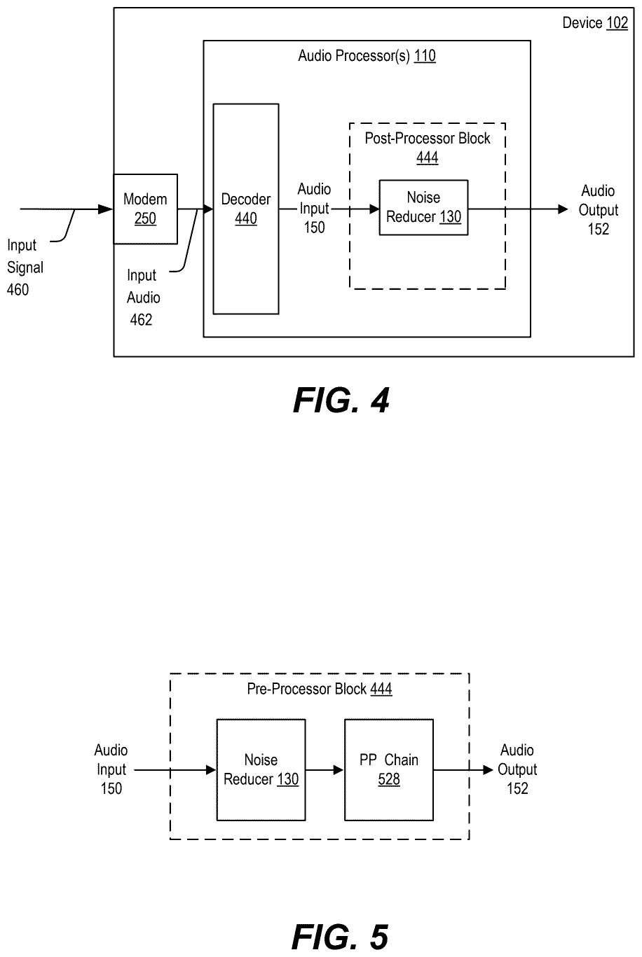

Referring to FIG. 1, FIG. 1 is a block diagram of an illustrative aspect of a system 100 operable to perform power-based noise reduction during a voice call, in accordance with the present disclosure. The system 100 includes a device 102, such as a portable electronic device, configured to process an audio input 150 during a voice call. In some embodiments, the device 102 processes the audio input 150 for transmission to another device, as described further herein at least with reference to FIG. 2. In other embodiments, the device 102 processes the audio input 150 for playout, such as via a speaker, as described further herein at least with reference to FIG. 4.

In an illustrative example, the voice call is associated with telephonic communication between a user of the device 102 and another device over one or more wired or wireless communication networks (e.g., long-term evolution (LTE), New Radio (NR), etc.) (LTE is a trademark of European Telecommunications Standards Institute). In a particular aspect, the voice call is over an LTE network. Additionally, or alternatively, the voice call is over at least one of an NR network, a 5G network, a beyond 5G wireless network, or a combination thereof. In some implementations, the voice call includes a connected mode discontinuous reception (CDRx) call.

The device 102 includes a memory 104, a battery 106, a power sensor 108, and one or more audio processors 110. In some implementations, the device may include an additional processor, such as a central processing unit (CPU).

The memory 104 is configured to store one or more thresholds 114 and data associated with multiple modes 116. In some embodiments, the memory stores threshold information that includes or indicates the threshold 114. The threshold 114 may include one or more thresholds, such as one or more power level thresholds. The threshold 114 may be set by a user or manufacturer of the device, or by a network service provider.

The modes 116 may include one or more noise reducer modes. For example, each of the multiple modes 116 may be associated with a mode or a configuration of a noise reducer 130 of the audio processor 110 configured to process an audio input associated with a voice call. To illustrate, the multiple modes may include a first mode having a first power consumption rate by the noise reducer 130, and a second mode having a second power consumption rate by the noise reducer 130 that is less than the first power consumption rate. In some implementations, at least one mode of the multiple modes 116 is associated with the noise reducer 130 being deactivated or bypassed. As illustrative, non-limiting examples, the modes 116 can include a neural network noise reduction engine mode, an echo cancellation mode, a noise suppression mode, an echo cancellation noise suppression (ECNS) mode, a single microphone echo cancellation noise suppression (SMECNS) mode, a filter-based noise reduction mode having a power consumption rate that is less than a power consumption rate of the neural network noise reduction engine mode, a deactivated mode, or a combination thereof.

In some implementations, the memory 104 is configured to buffer the audio input 150, such as the audio input 150 (that corresponds to a voice call) from an audio source. Alternatively, in other implementations, the device 102 includes another memory (e.g., a buffer) that is configured to buffer the audio input 150.

The battery 106 is configured to store and provide power to one or more components of the device 102. In some implementations, the battery 106 is configured to be re-chargeable. For example, the battery 106 can be charged by another power source, such as a power source that is external to the device 102.

The power sensor 108 is configured to monitor or determine a power level, a charging status (e.g., charging or non-charging), or both, of the battery 106. The power sensor 108 may be configured to generate a power indicator 140 that includes or indicates the power level of the battery 106, the charging status (e.g., a charging state), or a combination thereof. In some implementations, the power sensor 108 is configured to transmit the power indicator 140 to another component of the device 102, such as one or more processors (e.g., the audio processor 110).

Although the device 102 is described as including the battery 106 and the power sensor 108, in other embodiments, the battery 106, the power sensor 108, or both, is external to the device 102. For example, the battery 106 can be external to the device 102 and coupled to the device 102.

The audio processor 110 may include a digital signal processor (DSP), one or more other types of processor, or a combination thereof. The audio processor 110 is configured, during the voice call, to obtain the audio input 150 (e.g., a user's voice data) of the voice call. The audio processor 110 is also configured to generate an audio output 152 based on the audio input 150. According to an aspect, the audio input 150 corresponds to one or more frames of voice data that are received for processing at the audio processor 110 during the voice call. For example, the audio input 150 can be received from an audio source, such as via a microphone that is implemented in or coupled to the device 102, or can be received from another device via a component of the device 102, such as via a modem of the device 102.

The audio processor 110 includes a mode selector 120 and a noise reducer 130. The mode selector 120 is configured to receive the power indicator 140 and to select at least one of the modes 116 based on the power indicator 140. In some examples, the mode selector 120 performs a comparison based on the power indicator 140 and the threshold 114, and the mode selector 120 selects the at least one mode based on a result of the comparison. Additionally, the mode selector 120 may configure the audio processor 110 (e.g., the noise reducer 130) to generate the audio output 152 based on the selected noise reducer mode.

Although the mode selector 120 is described as being included in the audio processor 110, in other implementations, the mode selector 120 may not be included in the audio processor 110. In some examples, the mode selector 120 is included in another processor, such as a CPU of the device 102. Accordingly, the mode selector 120 may indicate a selected mode to the audio processor 110 to configure the noise reducer 130, one or more components of the audio processor 110, or a combination thereof.

The noise reducer 130 is configured to operate based on the selected noise reducer mode, such as a noise reducer mode 142. In some examples, the noise reducer 130 is configured perform a noise reduction operation, an echo cancellation operation, a noise suppression operation, a filter-based noise suppression operation, or a combination thereof. As another example, the noise reducer 130 may alternatively be configured to be deactivated or bypassed such that the noise reducer 130 does not perform the noise reduction operation, the echo cancellation operation, the noise suppression operation, the filter-based noise suppression operation, or a combination thereof. In some implementations, the noise reducer mode 142 includes a command to use or configure the audio processor 110 or the noise reducer 130 according to the selected mode.

The noise reducer 130 may include one or more noise reduction engines, such a first engine 131 and a second engine 132. In some implementations, the first engine 131 includes a neural network noise reduction engine (e.g., a neural network engine configured to perform echo cancellation, noise suppression, or a combination thereof), and the second engine 132 includes a non-neural network noise reduction engine. The non-neural network noise reduction engine may include an echo cancellation noise suppression (ECNS) engine, a single microphone echo cancellation noise suppression (SMECNS) engine, a filter-based noise reduction engine or circuitry, or a combination thereof. In some implementations, the noise reducer 130 is configured to perform an echo cancellation operation, a noise suppression operation, or a combination thereof.

In some implementations, the noise reducer 130 can be configured, according to a first mode, to use the first engine 131 (e.g., a neural network noise reduction engine), when the power level of the battery 106 is greater than a first threshold, when the battery 106 is in a charging state, or a combination thereof. Alternatively, the noise reducer 130 can be configured, according to a second mode, to use the second engine 132 when the power level is less than or equal to the first threshold. In some embodiments, the noise reducer 130 is configured to perform an echo cancellation noise suppression (ECNS) operation or a single microphone echo cancellation noise suppression (SMECNS) operation when the power level is less than or equal to the first threshold. Alternatively, the noise reducer 130 can be configured to be deactivated or bypassed when the power level of the battery 106 is less than or equal to a second threshold that is lower than the first threshold. If the noise reducer 130 is disabled (or deactivated), the noise reducer 130 outputs the audio input 150 as the audio output 152. Alternatively, disabling the noise reducer 130 may bypass the noise reducer 130 such that the audio input 150 is provided as the audio output 152.

Although the noise reducer 130 is described as including two engines 131, 132, in other implementations, the noise reducer 130 includes a single engine. Additionally, or alternatively, the audio processor 110 may include one or more components that may be selectively activated or deactivated (e.g., bypassed) based on the selected mode, such as the noise reducer mode 142. In some embodiments, the audio processor 110 includes a pre-/post-processor block that includes a pre-processor block as described further herein at least with reference to FIG. 2, a post-processor block as described further herein at least with reference to FIG. 4, or a combination thereof.

The configured noise reducer 130 processes the audio input 150 to generate the audio output 152. For example, the noise reducer 130 processes the audio input 150 based on the mode (e.g., the noise reducer mode 142) selected by the mode selector 120.

During operation, the power sensor 108 generates the power indicator 140. The mode selector 120 receives the power indicator 140 and selects a mode 116 based on the power indicator 140. The mode selector 120 configures the noise reducer 130 to operate according to the selected mode. To illustrate, the mode selector 120 may generate an indicator of the selected noise reducer mode 142 to cause the audio processor 110 to configure the noise reducer 130 based on the selected mode.

In some implementations, configuring the noise reducer 130 may include switching the noise reducer 130 between modes or switching the noise reducer 130 between configurations. In some embodiments, the audio processor 110 switches the noise reducer 130 from a neural network noise reduction engine mode to an SMECNS mode based on a determination that a power level indicated by the power indicator 140 is less than or equal to a first threshold. To illustrate, the first threshold may be equal to 10% of a capacity of the battery 106, as an illustrative, non-limiting example. In some other embodiments, the audio processor 110 is configured to switch the noise reducer 130 from the SMECNS mode to a deactivated or bypassed mode based on a determination that a power level indicated by the power indicator 140 is less than or equal to a second threshold. To illustrate, the second threshold may be equal to 1 or 2% of a capacity of the battery 106, as an illustrative, non-limiting example. In some embodiments, based on the determination that the power level indicated by the power indicator is less than or equal to the second threshold, the audio processor 110 deactivates or bypasses one or more components, such as one or more components of a pre-/post-processor block (e.g., the pre-processor block as described further herein at least with reference to FIG. 2, the post-processor block as described further herein at least with reference to FIG. 4, or a combination thereof). The deactivation or bypass of the one or more components of the pre-/post-processor block can result in power savings that are in addition to power savings that result from the deactivation or bypass of the noise reducer 130. As yet another embodiment, the audio processor 110 is configured to switch the noise reducer 130 to the neural network noise reduction engine mode or the SMECNS mode based on a determination that the power indicator 140 indicates an active charging status of the battery 106.

Additionally, or alternatively, the audio processor 110 may include one or more components that may be selectively activated or deactivated (e.g., bypassed) based on the selected mode, such as the noise reducer mode 142. In some embodiments, the audio processor 110 includes a pre-/post-processor block that includes a pre-processor block as described further herein at least with reference to FIG. 2, a post-processor block as described further herein at least with reference to FIG. 4, or a combination thereof.

The device 102 may participate in a voice call and receive the audio input 150 based on the voice call. The audio processor 110 may generate, based on the selected noise reducer mode, the audio output 152 based on the audio input 150. As an illustrative example, the noise reducer 130 processes the audio input 150 to generate the audio output 152. In some embodiments, the audio output 152 is provided to an encoder prior to the audio output 152 being output as an encoded version of the audio output, or is provided to a digital-to-analog converter prior to being output by a speaker as playback.

In some implementations, the audio output 152 is provided for transmission to another device, as described further herein at least with reference to FIG. 2. Additionally, or alternatively, the audio output 152 may be provided for playout, such as via a speaker, as described further herein at least with reference to FIG. 4. In some implementations, the audio output 152 is stored at a memory, such as the memory 104.

A technical advantage of selectively configuring the noise reducer 130 based on the power indicator 140 includes operating the noise reducer 130 in low power consumption states to conserve battery power of the battery 106. To illustrate, a mode for the noise reducer 130 can be selected based on the power indicator 140. Accordingly, as a power level of the battery 106 decreases, the mode of the noise reducer 130 can be switched such that the noise reducer 130 is configured to operate and consume power at a lower power consumption rate or is configured to be deactivated. Accordingly, the noise reducer 130 can be selectively configured to reduce power consumption during a voice call, which can decrease the discharge rate of the battery 106, increase the usage time of the device 102 before having to recharge the battery 106, improve a user experience, or a combination thereof. Additionally, deliberately switching the mode or configuration of the noise reducer 130 or the audio processor 110 can help to conserve remaining battery capacity and thereby ensure a more efficient and prolonged voice call, such as a voice call over an LTE/NR network.

Referring to FIG. 2, FIG. 2 is a block diagram of an example of particular aspects of the system of FIG. 1, in accordance with some examples of the present disclosure. The device 102 of FIG. 2 includes the audio processor 110 and a modem 250.

The audio processor 110 is configured to obtain an audio input 150 (e.g., a user's voice data) of the voice call. According to an aspect, the audio input 150 corresponds to one or more frames of voice data that are received for processing at the audio processor 110 during the voice call. In an illustrative embodiment, the audio input 150 is received from an audio source, such as via a microphone that is implemented in or coupled to the device 102. The audio input 150 can be processed for transmission to another device as voice content of the voice call. For example, the audio processor 110 can process the audio input 150 to generate output audio 254, and the modem 250 may initiate transmission of the output audio 254 as output signal 256 to the other device as the voice content of the voice call, as described further herein.

The audio processor 110 includes the noise reducer and an encoder 204. In some embodiments, the audio processor 110 includes a pre-processor block 220, and the pre-processor block 220 optionally includes the noise reducer 130. Additionally, or alternatively, the pre-processor block 220 may include one or more components other than the noise reducer 130, as described further herein at least with reference to FIG. 3.

The encoder 240 is configured to receive the audio output 252 from the audio processor 110 and to encode the audio output 252 to generate output audio 254. The audio output 252, the output audio 254, or both, may include or correspond to the audio output 152 of FIG. 1.

The modem 250 is configured to receive the output audio 254, generate the output signal 256 based on the output audio 254, and initiate transmission of the output signal 256. For example, the device 102 may transmit the output signal 256 to another device.

Referring to FIG. 3, a block diagram depicts an example of the pre-processor block 220 that includes a media format converter 322, a synchronizer 324, the noise reducer 130, and a pre-processing chain 328. The pre-processor block 220 is configured to receive the audio input 150 and perform one or more operations based on the audio input 150 to generate the audio output 252.

The media format converter 322 is configured to convert a sampling rate of the audio input 150 to a sampling rate of the noise reducer 130. It is noted that if the sample rate of the audio input 150 is at the sampling rate of the noise reducer 130, then no conversion is performed by the media format converter 322. The synchronizer 324 is configured to synchronize the audio input 150 between one or more microphones with a reference point to enable the noise reducer 130 to cancel noise included in or associated with the audio input 150. The noise reducer 130 is configured to perform a noise reduction operation, an echo cancellation operation, a noise suppression operation, a filter-based noise suppression operation, or a combination thereof. In some embodiments, the noise reducer 130 includes a neural network noise reduction engine, a non-neural network noise reduction engine, or both. The non-neural network noise reduction engine may include an echo cancellation noise suppression (ECNS) engine, a single microphone echo cancellation noise suppression (SMECNS) engine, a filter-based noise reduction engine or circuitry, or a combination thereof. The pre-processing chain 328 is configured to perform one or more pre-processing operation on the audio input 150 (e.g., on a noise-reduced version of the audio input 150 that is output by the noise reducer 130). To illustrate, the pre-processing chain 328 may include a gain module, a filter, an infinite impulse response (IIR) filter, finite impulse response (FIR) filter, or a combination thereof, as illustrative, non-limiting examples.

In a particular optional embodiment, the pre-processor block 220 performs various pre-processing operations on the audio input 150 to generate the audio output 252. The pre-processing operations can include conversion between time domain and frequency domain, sound source separation, other types of audio processing, or a combination thereof.

In some implementations, one or more components of the pre-processor block 220 can be disabled (or bypassed) by the audio processor 110. In some example, the one or more components of the pre-processor block 220 are disabled (or bypassed) based on a mode (e.g., a noise reducer mode) selected by the mode selector 120. As a result, power consumption associated with audio processing during the voice call can be reduced. For example, the power consumption can be reduced based on a configuration (or selected mode) of the noise reducer 130, the pre-processor block 220, or a combination thereof.

Although the pre-processor block 220 is described as including the media format converter 322, the synchronizer 324, the noise reducer 130, and the pre-processing chain 328, the pre-processor block 220 may include fewer or additional components than described. In some examples, the pre-processor block 220 is not include the media format converter 322 and the synchronizer 324. Alternatively, the pre-processor block 220 may not include the pre-processing chain 328.

Referring to FIG. 4, FIG. 4 is a block diagram of an example of particular aspects of the system of FIG. 1, in accordance with some examples of the present disclosure. The device 102 of FIG. 4 includes the audio processor 110 and the modem 250.

The modem 250 is configured to receive an input signal 460 from another device. The input signal 460 corresponds to one or more frames of voice data that are received for processing at the audio processor 110 during a voice call. The modem 250 can provide input audio 462 based on the input signal 460 to the audio processor 110.

The audio processor 110 includes a decoder 440 and the noise reducer 130. The decoder 440 is configured to receive the input audio 462 from the modem 250. The decoder 440 can decode the input audio 462 to generate decoded audio data, such as the audio input 150.

The noise reducer 130 may process the audio input 150 (e.g., the decoded audio data) to generate the audio output 152. In some implementations, the audio processor 110 configures the noise reducer 130 based on the power indicator 140, the noise reducer mode 142, or a combination thereof. The audio output 152 can be provided to a speaker that is integrated in or coupled to the device 102 for playback, stored in a memory device coupled to the device 102, processed (e.g., for speech recognition) by another component of the device 102, or a combination thereof. In some implementations, to provide the audio output 152 to the speaker for playback, the device includes a digital-to-analog converter (DAC) configured to receive the audio output 152 from the audio processor 110 and generate a signal that is provided to the speaker for playback.

In some implementations, the audio processor 110 may include a post-processor block 444 that includes the noise reducer 130. Additionally, or alternatively, the post-processor block 444 may include one or more other components. To illustrate, referring to FIG. 5, a block diagram depicts an example of the post-processor block 444. The post-processor block 444 is configured to receive the audio input 150 and perform one or more operations based on the audio input 150 to generate the audio output 152.

The post-processor block 444 includes the noise reducer 130 and a post-processing chain 528. The noise reducer 130 is configured perform a noise reduction operation, an echo cancellation operation, a noise suppression operation, a filter-based noise suppression operation, or a combination thereof. In some implementations, the noise reducer 130 includes a neural network noise reduction engine, a non-neural network noise reduction engine, or both. The non-neural network noise reduction engine may include an echo cancellation noise suppression (ECNS) engine, a single microphone echo cancellation noise suppression (SMECNS) engine, a filter-based noise reduction engine or circuitry, or a combination thereof. The post-processing chain 528 is configured to perform one or more pre-processing operation on the audio input 150 (e.g., on a noise-reduced version of the audio input 150 that is output by the noise reducer 130). To illustrate, the post-processing chain 528 may include a gain module, a filter, an infinite impulse response (IIR) filter, finite impulse response (FIR) filter, or a combination thereof, as illustrative, non-limiting examples.

In a particular optional embodiment, the post-processor block 444 performs various post-processing operations on the audio input 150 to generate the audio output 152. The post-processing operations can include conversion between time domain and frequency domain, sound source separation, other types of audio processing, or a combination thereof.

In some implementations, one or more components of the post-processor block 444 are be disabled (or bypassed) by the audio processor 110. For example, the one or more components of the post-processor block 444 may be disabled (or bypassed) based on a mode (e.g., a noise reducer mode) selected by the mode selector 120. In some embodiments, the one or more components of the post-processor block 444 may be disabled (or bypassed) in addition to and when the noise reducer 130 is disabled (or bypassed). As a result, power consumption associated with audio processing during the voice call can be reduced. For example, the power consumption can be reduced based on a configuration (or selected mode) of the noise reducer 130, the post-processor block 444, or a combination thereof.

Although the post-processor block 444 is described as including the noise reducer 130 and the post-processing chain 528, the post-processor block 444 may include fewer or additional components than described. For example, the post-processor block 444 may not include the post-processing chain 528.

In some examples, the audio processor 110 can perform audio processing operations in the receive path, as described with reference to at least FIG. 4, concurrently with performing audio processing operation in the transmit path, as described at least with reference to FIG. 2. For example, the audio processor 110 can perform decoding operations and noise reducer operations of the input signal 460 received from another device concurrently with performing the data loading, noise reducer operations, and encoding operations of the audio input 150 obtained from a microphone coupled to the device 102.

Referring to FIG. 6, FIG. 6 is a timing diagram 600 of an illustrative aspect of a system operable to perform power-based noise reduction during a voice call, in accordance with some examples of the present disclosure. The system of FIG. 6 may include or correspond to the system 100.

The timing diagram 600 illustrates an example of operation of the device 102 in which transitions between an active state and a low-power state of the modem 250 are aligned with the transitions between the active state and the low-power state of the audio processor 110 to enable synchronized processing and power savings using a low power island mechanism (e.g., a low power island memory). The timing diagram 600 depicts modem operations 660 and audio processing operations (e.g., first audio processing operations 670, second audio processing operations 680, and third audio processing operations 690) during multiple cycles 658 associated with the voice call, including a first cycle (“cycle 1”) 658A and a second cycle (“cycle 2”) 658B. The first audio processing operations 670 of the audio processor 110 include operations while the noise reducer 130 is configured in a first mode, such a neural network noise reduction engine mode. The second audio processing operations 680 of the audio processor 110 include operations are while the noise reducer 130 is configured in a second mode, such as a non-neural network noise reduction engine mode. The third audio processing operations 690 of the audio processor 110 include operations are while the noise reducer 130 is configured in a third mode, such as a disabled or deactivated mode. It is noted the audio processing operations 696 of the third audio processing operations 690 represent operations by the encoder 240 or the decoder 440. Additionally, the audio processing operations of each of the first audio processing operations 670 and the second audio processing operations 680 include a portion that corresponds to the audio processing operations 696 (of the encoder 240 or the decoder 440).

In each cycle 658, an awake period 662 indicates a time period in which the modem 250 is in an active state, and a low-power period 664 indicates a time period in which the modem 250 is not active and can enter a low-power state (e.g., a Deep/Light Sleep (“DLS”) mode) to conserve power. In a particular embodiment, the voice call is a connected mode discontinuous reception (CDRx) call, and timing criteria associated with the cycles 658 (e.g., the length of the awake period 662 and the length of the low-power period 664) are based on a CDRx cycle configuration. In an illustrative, non-limiting example, the duration of each cycle 658 is 40 milliseconds (ms), the duration of the awake period 662 is 20 ms, and the duration of the low-power period 664 is 20 ms. The low-power period 664 having the same duration as the awake period 662 is provided as an illustrative example, in other examples the low-power period 664 can be shorter or longer than the awake period 662 based on a cycle configuration.

The first cycle 658A begins with an awake period 662A, during which the modem 250 and the audio processor 110 transition from a low-power state to an active state. During the awake period 662, the modem 250 performs one or more uplink transmissions, one or more downlink transmissions, or a combination thereof, associated with the voice call. The audio processor 110 performs audio processing operations during an audio processing period 672A, 682A, or 692A, e.g., data loading, noise reducer configuration, encoding or decoding operations of the audio input 150, or a combination thereof. In an illustrative example, the audio input 150 represents 40 ms of audio content. In an example, a first portion of the audio input 150 includes microphone data that was buffered while the audio processor 110 was in the low-power state and retrieved upon the audio processor 110 transitioning to the active state. In an example, a second portion of the audio input 150 includes microphone data that was at least partially buffered subsequent to the audio processor 110 transitioning to the active state. In another example, all of the audio input 150 can be buffered while the audio processor 110 was in the low-power state. In yet another example, all of the audio input 150 can be added to the buffer subsequent to the audio processor 110 transitioning to the active state. To illustrate, the audio processor 110 can retrieve portions of the audio input 150 that are being written to the buffer in the active state, that have previously been written to the buffer in the low-power state, or a combination thereof.

The device 102 thus performs audio data retrieval, noise reducer configuration, audio enhancement, and encoding or decoding to generate the audio output 152 at the audio processor 110. The device 102 also performs, during the awake period 662A, reception of the audio input 150 via the modem 250 or transmission of the audio output 152 (e.g., the output audio 252 after encoding of the audio output 152) via the modem 250. Upon completion of the awake period 662A, the modem 250 halts operations and enters a low-power state during a low-power period 664A. To illustrate, the modem 250 ceases uplink and downlink activity and transitions to a sleep mode (or other low-power state) for the remainder of the first cycle 658A. Additionally, the audio processor 110 completes the audio processing operations 670, 680, or 690 and, upon completion of the audio processing period 672A, 682A, or 692A, enters a low-power state. To illustrate, the audio processor 110 completes the audio processing operations 670, 680, or 690 of the audio input 150 and transitions to a low-power state.

Upon completion of the low-power period 664A of the first cycle 658A, the second cycle 658B commences with an awake period 662B, during which the modem 250 and the audio processor 110 each transition from a low-power state to an active state. During the awake period 662B, the modem 250 resumes uplink and/or downlink activity associated with the voice call, and the audio processor 110 resumes processing of the audio input 150 to generate a next set of audio output 152 for transmission via the modem 250 or output via a speaker.

To illustrate, the audio processor 110 performs audio processing operations 670, 680, or 690 during a respective audio processing period 672B, 682A, 692A of the awake period 662B, e.g., data loading, noise reducer operations, and encoding or decoding operations of one or more additional portions of the audio input 150. In an example, a third portion of the audio input 150 includes microphone data that was buffered during the low-power period 664A and retrieved upon the audio processor 110 transitioning to the active state.

Upon completion of the awake period 662B, the modem 250 halts operations and enters a low-power state during a low-power period 664B. To illustrate, the modem 250 ceases uplink and downlink activity and transitions to a sleep mode (or other low-power state) for the remainder of the second cycle 658B. Additionally, the audio processor 110 completes audio processing operations and, upon completion of the audio processing period 672B, 682B, or 692B, enters a low-power state. To illustrate, the audio processor 110 completes processing of the audio input 150 and transitions to a low-power state.

Synchronization of the modem operations 660 with the audio processing operations 670, 680, or 690 can be performed using a voice call timer to schedule audio processing threads at the audio processor 110 according to timing criteria of the voice call. For example, according to some aspects, the voice call timer is responsible for scheduling threads of a voice call according to the voice call timing criteria. In a particular aspect, the voice timer can correspond to a software thread of the audio processor 110 that assigns resources, such as clocks and memory bandwidth, to the various subscribed threads so that resources are allocated to audio processing threads during awake periods and deallocated from the audio processing threads during the low-power periods. A central sleep manager can be configured to trigger entry into a low power island state in response to detecting that the audio processing threads are idle (e.g., completed). For example, the central sleep manager is configured to track processing threads at the audio processor 110 and control transitions of the audio processor 110 between an active state and a low power island state. In a particular example, the central sleep manager corresponds to a duty cycle manager and is configured to trigger entry into a low power island state in response to detecting that the audio processing threads are idle. By using the voice call timer to schedule the audio processing threads, the voice call timer can ensure that all of the audio processing threads are idle at the audio processor 110 as early as possible, enabling the central sleep manager to trigger entry into the low power island state and resulting in power savings.

By having different audio processing operations 670, 680, and 690 associated with a voice call based on a power indicator (e.g., the power indicator 140), the audio processor 110 can enter and be in the low-power state for different periods. Accordingly, the audio processor 110 may select to perform the audio processing operations 670, 680, and 690 to control or reduce power consumption of the audio processor 110. In some examples, to reduce power consumption of the audio processor 110, the audio processor 110 transitions from performing the first audio processing operations 670 to performing the second audio processing operations 680 or the third audio processing operations 690. In some other examples, to reduce power consumption of the audio processor 110, the audio processor 110 transitions from performing the second audio processing operations 680 to performing the third audio processing operations 690.

Referring to FIG. 7, FIG. 7 is a diagram of an illustrative aspect of an integrated circuit 700 operable to perform power-based noise reduction during a voice call, in accordance with some examples of the present disclosure. FIG. 7 depicts an embodiment 700 of the device 102 as an integrated circuit 702 that includes one or more processors 710. The one or more processors 710 include the audio processor 110 that includes the noise reducer 130, and optionally include the modem 250, a pre/post-processor block 770, a codec 772, a voice call timer, a central sleep manager, or a combination thereof. The pre/post-processor block 770 may include or correspond to the pre-processor block 220, the post-processor block 444, or a combination thereof.

The codec 772 may include or correspond to the encoder 240, the decoder 440, or a combination thereof. The audio processor 110 includes the noise reducer 130 and optionally includes the pre/post-processor block 770, the codec 772, or a combination there.

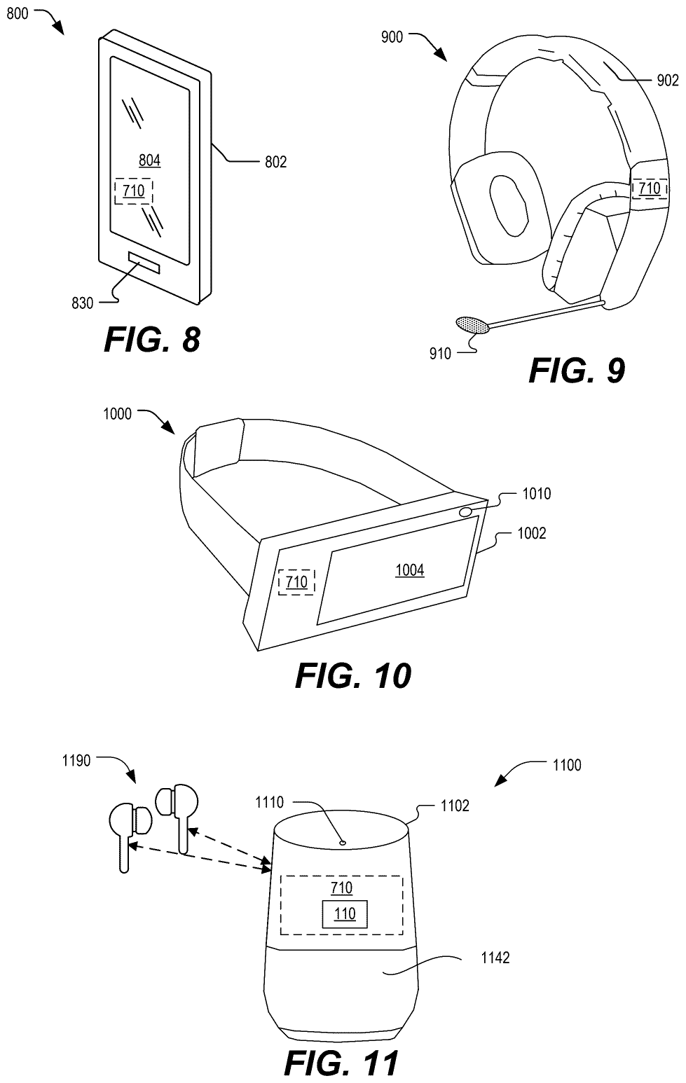

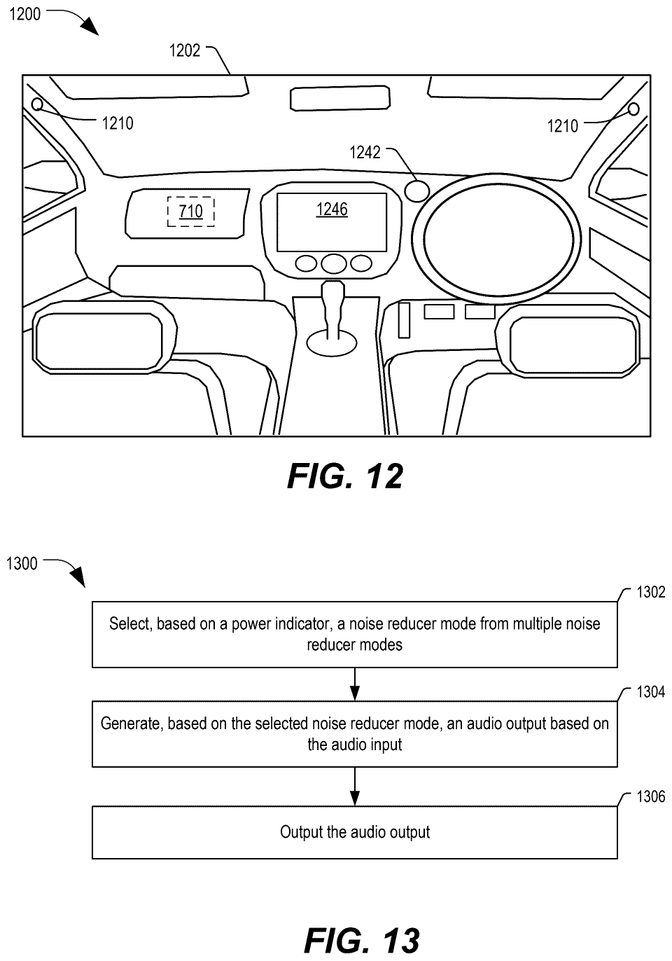

The integrated circuit 702 also includes a data input 704, such as one or more microphone inputs and/or bus interfaces, to enable audio data 708 to be received for processing. The audio data 708 can correspond to the audio input 150, the input signal 460, the input audio 462, or a combination thereof, as illustrative, non-limiting examples. The integrated circuit 702 also includes a signal output 706, such as a bus interface, to enable sending of an output signal 712, such as the audio output 152, the output audio 254, or the output signal 256, as illustrative, non-limiting examples. The integrated circuit 702 enables the audio processor 110 to be integrated (e.g., included as a component) in a system that includes microphones, such as a mobile phone or tablet computer device as depicted in FIG. 8, a headset device that includes a microphone configured to provide the audio data 708, as depicted in FIG. 9, a wearable electronic device as depicted in FIG. 10, a voice-controlled speaker system as depicted in FIG. 11, or a vehicle as depicted in FIG. 12.

Referring to FIG. 8, FIG. 8 is a diagram of an illustrative aspect of a system 800 that includes a mobile device operable to perform power-based noise reduction during a voice call, in accordance with some examples of the present disclosure. FIG. 8 depicts an embodiment 800 in which the device 102 includes a mobile device 802, such as a phone or tablet computer device, as illustrative, non-limiting examples. The mobile device 802 includes a microphone 830 and a display screen 804. The one or more processors 710 including the audio processor 110 are integrated in the mobile device 802 and are illustrated using dashed lines to indicate internal components that are not generally visible to a user of the mobile device 802. In a particular example, the audio processor 110 is configured to, responsive to user instructions (e.g., received via a graphical user interface at the display screen 804), initiate power-based noise reduction during a voice call and to align active periods of audio processing with call timing criteria to enable low-power operation (e.g., to support a low power island state) during the voice call.

Referring to FIG. 9, FIG. 9 is a diagram of an illustrative aspect of system 900 that includes a headset operable to perform power-based noise reduction during a voice call, in accordance with some examples of the present disclosure. FIG. 9 depicts an embodiment 900 in which the device 102 includes a headset device 902. The headset device 902 includes a microphone 910, and the one or more processors 710 including the audio processor 110 are integrated in the headset device 902. In a particular example, the audio processor 110 is configured to, responsive to user instructions (e.g., received via one or more user controls of the headset device 902, or via a speech interface, as non-limiting examples), initiate power-based noise reduction during a voice call to enable reduced power consumption during the voice call. Although illustrated as an audio headset, in other embodiments the headset device 902 can correspond to an extended reality headset, such as a virtual reality, mixed reality, or augmented reality headset.

Referring to FIG. 10, FIG. 10 is a diagram of an illustrative aspect of a system 1000 that includes a wearable electronic device operable to perform power-based noise reduction during a voice call, in accordance with some examples of the present disclosure. FIG. 10 depicts an embodiment 1000 in which the device 102 includes a wearable electronic device 1002, illustrated as a “smart watch.” A microphone 1010 and the one or more processors 710 including the audio processor 110 are integrated into the wearable electronic device 1002. In a particular example, the audio processor 110 is configured to, responsive to user instructions, such as via a graphical user interface at a display screen 1004 of the wearable electronic device 1002, initiate context-based noise reduction during a voice call to enable reduced power consumption during the voice call. In a particular example, the wearable electronic device 1002 includes a haptic device that provides a haptic notification (e.g., vibrates) in response to detection of an incoming call during which the user can initiate context-based noise reduction. For example, the haptic notification can cause a user to look at the display screen 1004 of the wearable electronic device 1002 to see a displayed notification indicating an incoming call, including a prompt to perform power-based noise reduction during the call with the calling party. The wearable electronic device 1002 can thus alert a user of the option to perform context-based noise reduction during a voice call.

Referring to FIG. 11, FIG. 11 is a diagram of an illustrative aspect of a system 1100 that includes a voice-controlled speaker system operable to perform power-based noise reduction during a voice call, in accordance with some examples of the present disclosure. FIG. 11 is an embodiment 1100 in which the device 102 includes a wireless speaker and voice activated device 1102. The wireless speaker and voice activated device 1102 can have wireless network connectivity and is configured to execute an assistant operation. A microphone 1110 and the one or more processors 710 including the audio processor 110 are included in the wireless speaker and voice activated device 1102. The wireless speaker and voice activated device 1102 also includes a speaker 1142 and supports use of a wireless headset, illustrated as a pair of in-ear earphones 1190, which can optionally be used by a user for participating in voice calls via the wireless speaker and voice activated device 1102. During operation, in response to receiving a verbal command identified as user speech via the microphone 1110 or via wireless signaling from the earphones 1190, the wireless speaker and voice activated device 1102 can execute assistant operations, such as via execution of a voice activation system (e.g., an integrated assistant application). The assistant operations can include initiating power-based noise reduction during an ongoing voice call or during initiation of a voice call.

Referring to FIG. 12, FIG. 12 is a diagram of an illustrative aspect of a system 1200 that includes a vehicle 1202 operable to perform power-based noise reduction during a voice call, in accordance with some examples of the present disclosure. FIG. 12 depicts an embodiment 1200 in which the device 102 corresponds to, or is integrated within, a vehicle 1202, illustrated as a car, such as an electric car. The vehicle 1202 includes the one or more processors 710 including the audio processor 110. The vehicle 1202 also includes microphones 1210 positioned to capture utterances of an operator and/or one or more users of the vehicle 1202. User voice activity detection can be performed based on audio signals received from the microphones 1210, including one or more user commands to initiate power-based noise reduction during an ongoing voice call, in response to accepting an incoming voice call, or during initiation of a voice call. For example, when an incoming voice call is detected, the user may be prompted via a display 1246 or via the one or more speakers 1242 if the user would like to initiate power-based noise reduction during the call with the calling party.

Referring to FIG. 13, FIG. 13 is flowchart of an example of a method 1300 of power-based noise reduction during a voice call, in accordance with some examples of the present disclosure. In a particular aspect, one or more operations of the method 1300 are performed by device 102, the audio processor 110, the mode selector 120, the noise reducer 130, the pre-processor block 220, the encoder 240, the modem 250, the decoder 440, the post-processor block 444, the processor 710, the pre/post-processor block 770, the codec 772, or a combination thereof. In some implementations, the one or more operations of the method 1300 are performed by audio processor, such as the audio processor 110. The audio processor may be included in an integrated circuit, such as the integrated circuit 702, may be integrated into a portable electronic device, such as the device 102, or a combination thereof.

At block 1302, the method 1300 includes selecting, based on a power indicator, a noise reducer mode from multiple noise reducer modes. For example, the power indicator can include or correspond to the power indicator 140. In some embodiments, the power indicator includes or indicates a power level of a battery (e.g., the battery 106), a charging status (e.g., charging or not charging), or a combination thereof. The noise reducer mode and the multiple noise reducer modes may include or correspond to the noise reducer mode 142 and the noise reducer modes 116, respectively. The multiple noise reducer modes may include a neural network noise reduction engine mode, a non-neural network noise reduction engine mode, an echo cancellation mode, a noise suppression mode, an ECNS mode, an SMECNS mode, a filter-based noise reduction mode having a power consumption rate that is less than a power consumption rate of the neural network noise reduction engine mode, a deactivated mode, a pre-processor block mode, a post-processor block mode, or a combination thereof, as illustrative, non-limiting examples. In some implementations, the noise reducer mode is selected by the audio processor 110, such as by the mode selector 120.

At block 1304, the method 1300 includes generating, based on the selected noise reducer mode, an audio output based on an audio input that corresponds to a voice call. For example, the audio output may include or correspond to the audio output 152, the output audio 254, the output signal 256, or the output signal 712. The audio input may include or correspond to the audio input 150, the input signal 460, the input audio 462, or the audio data 708. The voice call can be over a long-term evolution (LTE) network, a new radio (NR) network, a fifth generation (5G) wireless network, a beyond 5G wireless network, another type of communication network, or a combination thereof. In some implementations, the voice call is or includes a CDRx call.

At block 1306, the method 1300 includes outputting the audio output. The audio output may be output by the device 102, the audio processor 110, the noise reducer 130, the pre-processor block 220, the encoder 240, the modem 250, the decoder 440, the pre/post-processor block 770, the codec 772, or the signal output 706, as illustrative, non-limiting examples.

In some implementations, the method 1300 includes performing a comparison based on the power indicator and one or more thresholds. The one or more thresholds may include or correspond to threshold 114. The noise reducer mode can be selected based on a result of the comparison. The method 1300 may also include switching, based on the result of the comparison, from a first noise reducer mode of the multiple noise reducer modes to a second noise reducer mode of the multiple noise reducer modes. Switching from the first noise reducer mode to the second noise reducer mode may include configuring a noise reducer, such as the noise reducer 130, to operate according to the selected mode. In some implementations, the first noise reducer mode has a first power consumption rate and the second noise reducer mode has a second power consumption rate that is less than or first power consumption rate. In an illustrative, non-limiting example, the first noise reducer mode includes a neural network noise reduction engine mode, and the second noise reducer mode includes a non-neural network noise reduction engine mode. The non-neural network noise reduction engine mode may include an echo cancellation mode, a noise suppression mode, or a combination thereof, or a deactivation mode. As another illustrative, non-limiting example, the first noise reducer mode includes a first non-neural network noise reduction engine mode, and the second noise reducer mode includes a second non-neural network noise reduction engine mode. The first non-neural network noise reduction engine mode may include an echo cancellation mode, a noise suppression mode, or a combination thereof, and the second non-neural network noise reduction engine mode may include a deactivation mode.

In some implementations, the method 1300 includes transitioning, in association with a modem, from a low-power state to an active state during the voice call. In some examples, the modem includes or corresponds to the modem 250. Additionally, or alternatively, the method 1300 may include transitioning, in association with the modem, from the active state to the low-power state. For example, the audio processor 110 may transition to the low-power date upon completion of audio processor operations performed by the audio processor 110 (e.g., the noise reducer 130 and an encoder 240 or a decoder 440).

In some implementations, one or more operations of the method 1300 may be performed at or by a device, such as the device 102, that includes an audio processor, such as the audio processor 110. In some implementations, one or more operations of the method 1300 can be performed by the audio processor.

The audio processor may include a noise reducer, such as the noise reducer 130, that is configured or configurable to operate based on the selected noise reducer mode. For example, the audio processor, such as the mode selector 120 of the audio processor 110, can configure the noise reducer to operate based on the selected noise reducer mode (e.g., the nose reducer mode 142). Accordingly, the noise reducer may be configured or configurable to perform an echo cancellation operation, a noise suppression operation, a combination thereof, or no combination thereof.

In some implementations, the multiple noise reducer modes include the neural network noise reduction engine mode, the SMECNS mode, and the deactivated mode, as an illustrative, non-limiting example. In some such implementations, the method 1330 may include switching the noise reducer (e.g., the noise reducer 130) from the neural network noise reduction engine mode to the SMECNS mode based on a determination that a power level indicated by the power indicator is less than or equal to a first threshold. Additionally, or alternatively, the method 1300 may include switching the noise reducer from the SMECNS mode to the deactivated mode based on a determination that a power level indicated by the power indicator is less than or equal to a second threshold. Additionally, or alternatively, the method 1300 may include switching the noise reducer to the neural network noise reduction engine mode or the SMECNS mode based on a determination that the power indicator indicates an active charging status.

By configuring the noise reducer 130 based on the noise reducer mode selected based on the power indicator, the method 1300 enables power-based noise reduction during a voice call. For example, the audio processor may configure one or more components of the audio processor to process (or not process) the audio input based on the power indicator. Configuring the one or more components of the audio processor may be associated with a low-power state (or ultra-low-power state) of a power supply (e.g., a battery) or a charging or non-charging state of the power supply. As a result, power consumption of the audio processor may be reduced to thereby conserver power during the voice call.

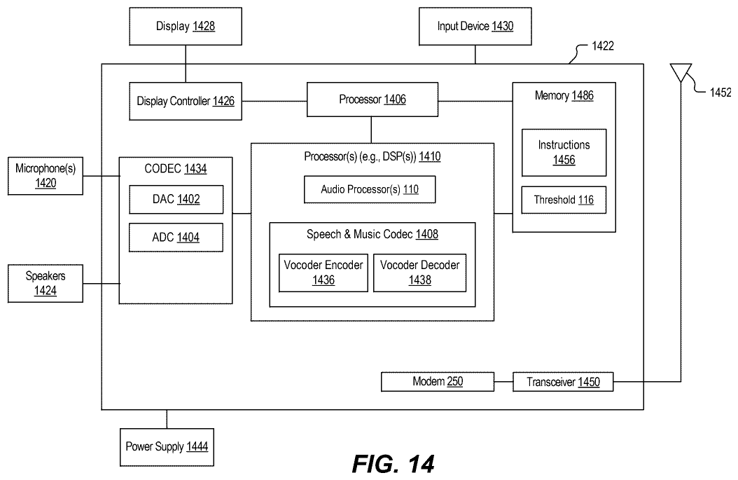

The method 1300 of FIG. 13 may be implemented by a field-programmable gate array (FPGA) device, an application-specific integrated circuit (ASIC), a processing unit such as a central processing unit (CPU), a DSP, a neural processing unit (NPU), a controller, another hardware device, firmware device, or any combination thereof. As an example, the method 1300 of FIG. 13 may be performed by a processor that executes instructions, such as described with reference to FIG. 14.

Referring to FIG. 14, FIG. 14 is a block diagram of a particular illustrative example of a device 1400 that is operable to perform power-based noise reduction during a voice call, in accordance with some examples of the present disclosure. In various embodiments, the device 1400 may have more or fewer components than illustrated in FIG. 14. In an illustrative embodiment, the device 1400 may include or correspond to the device 102. In an illustrative embodiment, the device 1400 may be configured to perform one or more operations described with reference to FIGS. 1-13.

In a particular embodiment, the device 1400 includes a processor 1406 (e.g., a CPU). The device 1400 may include one or more additional processors 1410 (e.g., one or more DSPs, one or more NPUs, or a combination thereof). In a particular aspect, the audio processor 110 is included in or corresponds to the processors 1410, the processor 1406, or a combination thereof. Additionally, or alternatively, the processor 1406, the processor 1410, or a combination thereof, may include or correspond to the processor 710. The processors 1410 may include a speech and music coder-decoder (CODEC) 1408 that includes a voice coder (“vocoder”) encoder 1436, a vocoder decoder 1438, or a combination thereof. In some embodiments, the speech and music codec 1408 corresponds to, or is included in, the encoder 240, the decoder 440, the codec 772, or a combination thereof. Additionally, or alternatively, in some other implementations, the speech and music CODEC 1408 may include or correspond to the audio processor 110.

The device 1400 may include a memory 1486 and a CODEC 1434. The memory 1486 may include instructions 1456 that are executable by the one or more additional processors 1410 (or the processor 1406) to implement the functionality described with reference to the audio processor 110, a power sensor (e.g., the power sensor 108), a pre/post-processor block 770 (e.g., the pre-processor block 220, the post-processor block 444, or the pre/post-processor block 770), a central sleep manager, a voice call timer, or any combination thereof. The device 1400 may include the modem 250 coupled, via a transceiver 1450, to an antenna 1452.

In a particular aspect, the memory 1486 is configured to store data used or generated by one or more components of the audio processor 110. For example, the memory 1486 is configured to buffer the audio input 150, the input signal 460, the input audio 462, or the audio data 708 received from an audio source. In a particular aspect, the memory 1486 is configured to buffer the input audio 462 or the audio data 708 received via the modem 250, the transceiver 1450, and the antenna 1452, from another device. In a particular aspect, the memory 1486 is configured to buffer microphone output received from the microphone 1420.

The device 1400 may include a display 1428 coupled to a display controller 1426. One or more speakers 1424 and one or more microphones 1420 may be coupled to the CODEC 1434. In a particular aspect, the audio input 124, the audio data 708, or both, are based on microphone output of the one or more microphones 1420. In a particular aspect, the one or more microphones 1420 include the microphone 830, the microphone 910, the microphone 1010, the microphone 1110, the microphone 1210, or a combination thereof. The CODEC 1434 may include a digital-to-analog converter (DAC) 1402, an analog-to-digital converter (ADC) 1404, or both. In a particular embodiment, the CODEC 1434 may receive analog signals from the microphone 1420, convert the analog signals to digital signals using the analog-to-digital converter 1404, and provide the digital signals to the speech and music codec 1408. According to an aspect, the digital signals corresponding to the microphone input may be processed by the audio processor 110. In a particular embodiment, the speech and music codec 1408 (e.g., the audio processor 110) may provide digital signals to the CODEC 1434. The CODEC 1434 may convert the digital signals to analog signals using the digital-to-analog converter 1402 and may provide the analog signals to the speaker 1424.

In a particular embodiment, the device 1400 may be included in a system-in-package or system-on-chip device 1422. In a particular embodiment, the memory 1486, the processor 1406, the processors 1410, the display controller 1426, the CODEC 1434, the transceiver 1450, and the modem 250 are included in the system-in-package or system-on-chip device 1422. In a particular embodiment, an input device 1430 and a power supply 1444 are coupled to the system-in-package or the system-on-chip device 1422. Moreover, in a particular embodiment, as illustrated in FIG. 14, the display 1428, the input device 1430, the speaker 1424, the microphone 1420, the antenna 1452, and the power supply 1444 are external to the system-in-package or the system-on-chip device 1422. In a particular embodiment, each of the display 1428, the input device 1430, the speaker 1424, the microphone 1420, the antenna 1452, and the power supply 1444 may be coupled to a component of the system-in-package or the system-on-chip device 1422, such as an interface or a controller.

The device 1400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, an extended reality (XR) device, a base station, a mobile device, or any combination thereof.

In conjunction with the described embodiments, an apparatus includes means for selecting, based on a power indicator, a noise reducer mode from multiple noise reducer modes. For example, the means for selecting the noise reducer mode can correspond to the device 102, the power sensor 108, the audio processor 110, the mode selector 120, the processor 710, the processor 1406, the one or more processors 1410, the memory 1486 storing the instructions 1465, one or more other circuits or components configured to select the noise reducer mode, or any combination thereof. The apparatus also include means for generating, based on the selected noise reducer mode, an audio output based on an audio input that corresponds to a voice call. For example, the means for generating the audio output can correspond to the device 102, the audio processor 110, the noise reducer 130, the pre-processor block 220, the encoder 240, the media format converter 322, the synchronizer 324, the PP chain 328, the decoder 440, the post-processor block 444, the PP chain 528, the processor 710, the pre/post-processor block 770, the codec 772, the processor 1406, the one or more processors 1410, the memory 1486 storing the instructions 1465, one or more other circuits or components configured to generate the audio output, or any combination thereof. The apparatus further includes means for outputting the audio output. For example, the means for outputting the audio output can correspond to the device 102, the audio processor 110, the noise reducer 130, the pre-processor block 220, the encoder 240, the modem 250, the media format converter 322, the synchronizer 324, the PP chain 328, post-processor block 444, the PP chain 528, the processor 710, the pre/post-processor block 770, the codec 772, the signal output 706, the speaker 1142, the pair of in-ear earphones 1190, the one or more speakers 1242, the processor 1406, the one or more processors 1410, the speakers 1424, the transceiver 1450, the memory 1486 storing the instructions 1465, one or more other circuits or components configured to output the audio output, or any combination thereof.

In some embodiments, a non-transitory computer-readable medium (e.g., a computer-readable storage device, such as the memory 1486) includes instructions (e.g., the instructions 1456) that, when executed by one or more processors (e.g., the audio processor 110, the processor 710, the one or more processors 1410, or the processor 1406), cause the one or more processors to select, based on a power indicator (e.g., the power indicator 140), a noise reducer mode (e.g., the noise reducer mode 142) from multiple noise reducer modes (e.g., the modes 116). The instructions (e.g., the instructions 1456), when executed by the one or more processors (e.g., the audio processor 110, the processor 710, the one or more processors 1410, or the processor 1406), also cause the one or more processors to generate, based on the selected noise reducer mode, an audio output (e.g., the audio output 152, the output audio 254, the output signal 256, an output of the processor 710 or the pre/post-processor block 770, or the output signal 712) based on an audio input (e.g., the audio input 150, the input signal 460, the input audio 462, or the audio data 708) that corresponds to a voice call. The instructions (e.g., the instructions 1456), when executed by the one or more processors (e.g., the audio processor 110, the processor 710, the one or more processors 1410, or the processor 1406), further cause the one or more processors to output the audio output (e.g., the audio output 152, the output audio 254, the output signal 256, an output of the processor 710 or the pre/post-processor block 770, or the output signal 712).

Particular aspects of the disclosure are described below in sets of interrelated Examples:

According to Example 1, a device includes a memory configured to buffer an audio input from an audio source, where the audio input corresponds to a voice call; and an audio processor configured to select, based on a power indicator, a noise reducer mode from multiple noise reducer modes; generate, based on the selected noise reducer mode, an audio output based on the audio input; and output the audio output.

Example 2 includes the device of Example 1, where the power indicator indicates a power level of a battery, a charging status, or a combination thereof.

Example 3 includes the device of Example 1 or Example 2, where the audio processor is further configured to perform a comparison based on the power indicator and one or more thresholds, and where the noise reducer mode is selected based on a result of the comparison.

Example 4 includes the device of any of Examples 1 to 3, where: the audio processor includes a noise reducer; and the noise reducer is configured to operate based on the selected noise reducer mode.

Example 5 includes the device of Example 4, where the noise reducer is configured to perform an echo cancellation operation, a noise suppression operation, or a combination thereof.

Example 6 includes the device of Example 4, where the multiple noise reducer modes include a neural network noise reduction engine mode, an echo cancellation mode, a noise suppression mode, an ECNS mode, an SMECNS mode, a filter-based noise reduction mode having a power consumption rate that is less than a power consumption rate of the neural network noise reduction engine mode, a deactivated mode, or a combination thereof.

Example 7 includes the device of any of Examples 4 to 6, where the audio processor is configured to switch the noise reducer from a neural network noise reduction engine mode to an SMECNS mode based on a determination that a power level indicated by the power indicator is less than or equal to a first threshold.

Example 8 includes the device of any of Examples 4 to 7, where the audio processor is configured to switch the noise reducer from an SMECNS mode to a deactivated mode based on a determination that a power level indicated by the power indicator is less than or equal to a second threshold.

Example 9 includes the device of any of Examples 4 to 8, where the audio processor is configured to switch the noise reducer to a neural network noise reduction engine mode or an SMECNS mode based on a determination that the power indicator indicates an active charging status.

Example 10 includes the device of any of Examples 1 to 9, and further includes an encoder configured to receive the audio output from the audio processor; or a DAC configured to receive the audio output from the audio processor.

Example 11 includes the device of any of Examples 1 to 10, further including a modem, and where the audio processor is configured to transition from a low-power state to an active state during the voice call, where the audio processor is configured to obtain the audio input; and after generation of the output audio during the active state, transition from the active state to the low-power state.

Example 12 includes the device of any of Examples 1 to 11, where the voice call is a CDRx call.

Example 13 includes the device of any of Examples 1 to 13, where the audio processor is integrated into a portable electronic device.

According to Example 14, a method of audio processing by an audio processor, the method includes selecting, based on a power indicator, a noise reducer mode from multiple noise reducer modes; generating, based on the selected noise reducer mode, an audio output based on an audio input that corresponds to a voice call; and outputting the audio output.

Example 15 includes the method of Example 14, and the method further includes configuring a noise reducer to operate based on the selected noise reducer mode, and where the noise reducer is configured to perform an echo cancellation operation, a noise suppression operation, or a combination thereof.

Example 16 includes the method of Example 14 or Example 15, and the method further includes performing a comparison based on the power indicator and one or more thresholds, where the noise reducer mode is selected based on a result of the comparison.

Example 17 includes the method of Example 16, and the method further includes switching, based on a result of the comparison, from a first noise reducer mode of the multiple noise reducer modes to a second noise reducer mode of the multiple noise reducer modes.

Example 18 includes the method of Example 17, where: the first noise reducer mode includes a neural network noise reduction engine mode having a first power consumption rate; the second noise reducer mode includes a non-neural network noise reduction engine mode having a second power consumption rate; and the second power consumption rate is less than the first power consumption rate.

Example 19 includes the method of any of Examples 14 to 18, where the multiple noise reducer modes include a neural network noise reduction engine mode, an SMECNS mode, a deactivated mode, or a combination thereof.

According to Example 20, a non-transitory computer-readable medium storing instructions that, when executed by one or more processors, cause the one or more processors to select, based on a power indicator, a noise reducer mode from multiple noise reducer modes; generate, based on the selected noise reducer mode, an audio output based on an audio input that corresponds to a voice call; and output the audio output.

According to Example 21, an apparatus includes: means for selecting, based on a power indicator, a noise reducer mode from multiple noise reducer modes; means for generating, based on the selected noise reducer mode, an audio output based on an audio input that corresponds to a voice call; and means for outputting the audio output.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. A storage medium may be coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to buffer an audio input from an audio source, wherein the audio input corresponds to a voice call; and
an audio processor configured to:
select, based on a power indicator, a noise reducer mode from multiple noise reducer modes;
generate, based on the selected noise reducer mode, an audio output based on the audio input; and
output the audio output.

2. The device of claim 1, wherein the power indicator indicates a power level of a battery, a charging status, or a combination thereof.

3. The device of claim 1, wherein the audio processor is further configured to:
perform a comparison based on the power indicator and one or more thresholds, and
wherein the noise reducer mode is selected based on a result of the comparison.

4. The device of claim 1, wherein:
the audio processor includes a noise reducer; and
the noise reducer is configured to operate based on the selected noise reducer mode.

5. The device of claim 4, wherein the noise reducer is configured to perform an echo cancellation operation, a noise suppression operation, or a combination thereof.

6. The device of claim 4, wherein the multiple noise reducer modes include a neural network noise reduction engine mode, an echo cancellation mode, a noise suppression mode, an echo cancellation noise suppression (ECNS) mode, a single microphone echo cancellation noise suppression (SMECNS) mode, a filter-based noise reduction mode having a power consumption rate that is less than a power consumption rate of the neural network noise reduction engine mode, a deactivated mode, or a combination thereof.

7. The device of claim 4, wherein the audio processor is configured to switch the noise reducer from a neural network noise reduction engine mode to a single microphone echo cancellation noise suppression (SMECNS) mode based on a determination that a power level indicated by the power indicator is less than or equal to a first threshold.

8. The device of claim 4, wherein the audio processor is configured to switch the noise reducer from a single microphone echo cancellation noise suppression (SMECNS) mode to a deactivated mode based on a determination that a power level indicated by the power indicator is less than or equal to a second threshold.

9. The device of claim 4, wherein the audio processor is configured to switch the noise reducer to a neural network noise reduction engine mode or a single microphone echo cancellation noise suppression (SMECNS) mode based on a determination that the power indicator indicates an active charging status.

10. The device of claim 1, further comprising:
an encoder configured to receive the audio output from the audio processor; or
a digital-to-analog converter (DAC) configured to receive the audio output from the audio processor.

11. The device of claim 1, further comprising:
a modem, and
wherein the audio processor is configured to:
transition from a low-power state to an active state during the voice call, wherein the audio processor is configured to obtain the audio input; and
after generation of the output audio during the active state, transition from the active state to the low-power state.

12. The device of claim 1, wherein the voice call is a connected mode discontinuous reception (CDRx) call.

13. The device of claim 1, wherein the audio processor is integrated into a portable electronic device.

14. A method of audio processing by an audio processor, the method comprising:
selecting, based on a power indicator, a noise reducer mode from multiple noise reducer modes;
generating, based on the selected noise reducer mode, an audio output based on an audio input that corresponds to a voice call; and
outputting the audio output.

15. The method of claim 14, further comprising:
configuring a noise reducer to operate based on the selected noise reducer mode, and
wherein the noise reducer is configured to perform an echo cancellation operation, a noise suppression operation, or a combination thereof.

16. The method of claim 14, further comprising performing a comparison based on the power indicator and one or more thresholds, wherein the noise reducer mode is selected based on a result of the comparison.

17. The method of claim 16, further comprising switching, based on a result of the comparison, from a first noise reducer mode of the multiple noise reducer modes to a second noise reducer mode of the multiple noise reducer modes.

18. The method of claim 17, wherein:
the first noise reducer mode includes a neural network noise reduction engine mode having a first power consumption rate;
the second noise reducer mode includes a non-neural network noise reduction engine mode having a second power consumption rate; and
the second power consumption rate is less than the first power consumption rate.

19. The method of claim 14, wherein the multiple noise reducer modes include a neural network noise reduction engine mode, a single microphone echo cancellation noise suppression (SMECNS) mode, a deactivated mode, or a combination thereof.

20. A non-transitory computer-readable medium storing instructions that, when executed by one or more processors, cause the one or more processors to:
select, based on a power indicator, a noise reducer mode from multiple noise reducer modes;
generate, based on the selected noise reducer mode, an audio output based on an audio input that corresponds to a voice call; and
output the audio output.
